(19) United States
(12) Patent Application Publication
(10) Pub. No.: US 2026/0304153 A1
(43) Pub. Date: Oct. 1, 2026

(54) COMMUNICATION METHOD, COMMUNICATION DEVICE, NETWORK FUNCTION ENTITY, AND ELECTRONIC DEVICE

(71) Applicant: Beijing Xiaomi Mobile Software Co., Ltd., Beijing (CN)

(72) Inventor: Xing YANG, Beijing (CN)

(73) Assignee: Beijing Xiaomi Mobile Software Co., Ltd., Beijing (CN)

(21) Appl. No.: 19/476,591

(22) PCT Filed: Apr. 18, 2023
(86) PCT No.: PCT/CN2023/089076

§ 371 Date: Oct. 17, 2025

(51) Int. Cl. H04W 24/02; H04L 41/16; H04W 76/20

(52) U.S. Cl. CPC H04W 24/02; H04L 41/16; H04W 76/20

(57) ABSTRACT

Embodiments of the present disclosure relate to the technical field of communications, and provide a communication method, a communication device, a network function entity, and an electronic device. The method comprises: a first network function entity of a communication device delivers first configuration information downwards to a second network function entity, wherein the first network function entity and the second network function entity are network function entities of an access layer, and the first configuration information is used for configuring a first artificial intelligence (AI) model. According to the embodiments of the present disclosure, an AI model is transmitted in the access layer and can be used for the management process of a wireless communication system in the 3GPP, and a foundation is laid for an access network device to manage the AI model.

### CROSS REFERENCE

The present application is a national phase application of International Application No. PCT/CN 2023/089076, filed on Apr. 18, 2023, and the entire contents thereof are incorporated herein by reference.

### TECHNICAL FIELD

The present disclosure relates to the field of communication technology, and in particular, to a communication method, a communication device, an electronic device, a computer-readable storage medium, and a computer program product.

### BACKGROUND

Artificial intelligence (AI) technology can generate models from large amounts of training data, which can then be used to predict events. In communication systems, AI models can be used for prediction and reasoning, improving system performance.

When AI models are trained on access network devices and AI reasoning is performed on terminal devices, the access network devices need to transmit the AI models to the terminal devices. When AI models are trained on terminal devices and AI reasoning is performed on the access network devices, the terminal devices need to transmit the AI models to the access network devices.

It should be noted that, information disclosed in the above background portion is provided only for better understanding of the background of the present disclosure, and thus it may contain information that does not form the prior art known by those ordinary skilled in the art.

### SUMMARY

The embodiments of the present disclosure provide a communication method, a communication device, a network function entity, an electronic device, a computer-readable storage medium, and a computer program product. The technical solution is as follows:

According to one aspect of an embodiment of the present disclosure, a communication method is provided, which is applied to a communication device. The method includes:
delivering, by a first network function entity of the communication device, first configuration information downward to a second network function entity of the communication device;
where the first network function entity and the second network function entity are network function entities of an access layer; and
the first configuration information is used to configure a first artificial intelligence (AI) model.

According to one aspect of an embodiment of the present disclosure, a communication method is provided, which is applied to a first network function entity. The method includes:
delivering first configuration information downward to a second network function entity;
where the first network function entity and the second network function entity are network function entities of an access layer; and
the first configuration information is used to configure a first artificial intelligence (AI) model.

According to one aspect of an embodiment of the present disclosure, a communication method is provided, which is applied to a second network function entity. The method includes:
obtaining first configuration information delivered downward by a first network function entity;
where the first network function entity and the second network function entity are network function entities of the access layer; and
the first configuration information is used to configure a first artificial intelligence (AI) model.

According to one aspect of an embodiment of the present disclosure, a communication device is provided, including:
a first delivering module, configured for a first network function entity of the communication device to deliver first configuration information downward to a second network function entity of the communication device;
where the first network function entity and the second network function entity are network function entities of an access layer; and
the first configuration information is used to configure a first artificial intelligence (AI) model.

According to one aspect of an embodiment of the present disclosure, a first network function entity is provided, including:
a second delivering module, configured to deliver first configuration information downward to a second network function entity;
where the first network function entity and the second network function entity are network function entities of an access layer; and
the first configuration information is used to configure a first artificial intelligence (AI) model.

According to one aspect of an embodiment of the present disclosure, a second network function entity is provided, including:
a first obtaining module, configured to obtain first configuration information delivered downward by a first network function entity;
where the first network function entity and the second network function entity are network function entities of an access layer; and
the first configuration information is used to configure a first artificial intelligence (AI) model.

According to one aspect of an embodiment of the present disclosure, an electronic device is provided, which includes a memory, a processor, and a computer program stored on the memory, and the processor executes the computer program to implement the steps of the method provided in the first aspect, the second aspect, or the third aspect.

According to one aspect of an embodiment of the present disclosure, a computer-readable storage medium is provided, on which a computer program is stored. When the computer program is executed by a processor, the steps of the method provided in the first aspect, the second aspect or the third aspect are implemented.

According to one aspect of an embodiment of the present disclosure, a computer program product is provided. When the computer program is executed by a processor, the steps of the method provided in the first aspect, the second aspect or the third aspect are implemented.

It is to be understood that both the foregoing general description and the following detailed description are exemplary and explanatory only and are not restrictive of the present disclosure.

### BRIEF DESCRIPTION OF THE DRAWINGS

In order to more clearly illustrate the technical solutions in the embodiments of the present disclosure, the following briefly introduces the drawings required for describing the embodiments of the present disclosure.

FIG. 1A is a schematic diagram of the architecture of a communication system shown in an embodiment of the present disclosure;

FIG. 1B is a hierarchical diagram of a control plane protocol stack in the related art;

FIG. 1C is a hierarchical diagram of a control plane protocol stack according to an embodiment of the present disclosure;

FIG. 1D is a schematic diagram of the structure of a PDCP PDU according to an embodiment of the present disclosure;

FIG. 2 is an interactive schematic diagram of a communication method according to an embodiment of the present disclosure;

FIG. 3A is a schematic flow chart of a communication method performed by a first communication device according to an embodiment of the present disclosure;

FIG. 3B is a schematic flow chart of a communication method performed by a second communication device according to an embodiment of the present disclosure;

FIG. 3C is a schematic flow chart of a communication method performed by a first communication device according to an embodiment of the present disclosure;

FIG. 3D is a schematic flow chart of a communication method performed by a second communication device according to another embodiment of the present disclosure;

FIG. 3E is a schematic flow chart of a communication method performed by a communication device according to another embodiment of the present disclosure;

FIG. 4A is a schematic flow chart of a communication method performed by a first network function entity according to an embodiment of the present disclosure;

FIG. 4B is a schematic flow chart showing a communication method performed by a first network function entity according to another embodiment of the present disclosure;

FIG. 5A is a schematic flow chart of a communication method performed by a second network function entity according to an embodiment of the present disclosure;

FIG. 5B is a schematic flow chart of a communication method performed by a second network function entity according to an embodiment of the present disclosure;

FIG. 6 is a schematic structural diagram of a communication device provided in an embodiment of the present disclosure;

FIG. 7A is a schematic structural diagram of a first network function entity provided by an embodiment of the present disclosure;

FIG. 7B is a schematic structural diagram of a second network function entity provided in an embodiment of the present disclosure;

FIG. 8 is a schematic structural diagram of an electronic device provided by an embodiment of the present disclosure.

### DETAILED DESCRIPTION

The embodiments of the present disclosure provide a communication method, a communication device, a network function entity, and a storage medium.

In a first aspect, an embodiment of the present disclosure provides a communication method, which is applied to a communication device. The method includes:
delivering, by a first network function entity of the communication device, first configuration information downward to a second network function entity of the communication device;
where the first network function entity and the second network function entity are network function entities of an access layer; and
the first configuration information is used to configure a first artificial intelligence (AI) model.

In the above embodiment, the first network function entity and the second network function entity are both located in the access layer, realizing the transmission of the AI model in the access layer, and the hierarchical relationship between the first network function entity and the second network

function entity is that the first network function entity is the higher layer of the second network function entity. The first network function entity delivers the first configuration information downward to the second network function entity, which means that the first configuration information is delivered downward to the lower layer of the access network and then to another communication device, realizing the transmission of the first configuration information across communication devices. This application can be used for the wireless communication system management process in 3GPP, laying the foundation for an access network device to manage the AI model.

In conjunction with some embodiments of the first aspect, in some embodiments, the method further includes:
determining, by the second network function entity, first transmission information based on the first configuration information, and delivering the first transmission information downward to a network function entity at lower layer;
where the first transmission information includes the first configuration information and first indication information, where the first indication information is used to indicate that the first transmission information carries information of the first network function entity.

In the above embodiment, the second network function entity determines the first transmission information based on the first configuration information, and the first transmission information includes information for indicating that the first transmission information carries the first network function entity, so that the second network function entity of the opposite communication device determines to deliver the first configuration information to the first network function entity instead of other network function entities after obtaining the first transmission information, thereby ensuring the accuracy of data transmission.

In combination with some embodiments of the first aspect, in some embodiments, the second network function entity is a PDCP entity or an RRCE entity.

In the above embodiment, the second network function entity can be a PDCP entity or an RRCS entity, which enhances the flexibility of the transmission AI model.

With reference to some embodiments of the first aspect, in some embodiments, the second network function entity is the PDCP entity, and the first transmission information is a first packet data convergence protocol protocol data unit (PDCP PDU).

In the above embodiment, the existing information of the PDCP entity is used as a carrier to send the first configuration information and the first indication information, which reduces the difficulty of implementing the solution.

In combination with some embodiments of the first aspect, in some embodiments, the second network function entity is the RRC entity, and the first transmission information is a first RRC message.

In the above embodiment, the first configuration information and the first indication information are sent using the existing message of the RRC entity as a carrier, which reduces the difficulty of implementing the solution.

In combination with some embodiments of the first aspect, in some embodiments, the wireless bearer corresponding to the PDCP entity that obtains the first configuration information is the same as the wireless bearer corresponding to the first network function entity or the wireless bearer corresponding to the first AI model.

In the above embodiment, the first network function entity sends the first configuration information to the PDCP entity corresponding to the radio bearer, thereby achieving the effect of standardized data transmission.

In combination with some embodiments of the first aspect, in some embodiments, the radio bearer corresponding to the first RRC message is the same as the radio bearer corresponding to the first network function entity or the radio bearer corresponding to the first AI model.

In the above embodiment, the RRC entity sets the radio bearer corresponding to the first RRC message to be the same as the radio bearer of the first network function entity or the first AI model, thereby achieving the effect of standardized data transmission.

In conjunction with some embodiments of the first aspect, in some embodiments, the first network function entity delivering the first configuration information downward to the second network function entity, further includes:
obtaining, by the first network function entity, bearer information;
where the bearer information is used to indicate at least one of the following: a radio bearer corresponding to the first network function entity; or
a radio bearer corresponding to the first AI model.

In the above embodiment, the first network function entity obtains the bearer information, which lays the foundation for orderly delivering the first configuration information downward to the network function entity of the next layer.

In conjunction with some embodiments of the first aspect, in some embodiments, the first configuration information includes at least one of the following:
adding information indicating an additional AI model, where the adding information includes the additional AI model and a model identifier of the additional AI model;
modifying information indicating a modified AI model, where the modifying information includes a model identifier of the modified AI model and a modified model parameter; or
deleting information indicating a deleted AI model, where the deleting information includes a model identifier of the deleted AI model.

In the above embodiment, the first configuration information may be used to instruct at least one of adding, modifying, and deleting an AI model, thereby achieving the function of flexible deployment of the AI model.

In conjunction with some embodiments of the first aspect, in some embodiments, the method further includes:
obtaining, by the first network function entity, second configuration information delivered upward by the second network function entity, where the second configuration information is used to configure a second AI model; and
configuring, by the first network function entity, the second AI model based on the second configuration information.

In the above embodiment, the first network function entity of the network device also has the ability to obtain the second configuration information of the opposite communication device, and can configure the second AI model based on the second configuration information, thereby achieving the effect of the network device configuring the AI model itself.

In conjunction with some embodiments of the first aspect, in some embodiments, before the first network function entity obtaining the second configuration information delivered upward by the second network function entity, the method further includes:
obtaining, by the second network function entity, second transmission information delivered upward by a network function entity at lower layer, where the second transmission information includes the second configuration information and second indication information, where the second indication information is used to indicate that the second transmission information carries information of the first network function entity; and
delivering the second transmission information upward to the first network function entity according to the second indication information.

The second network function entity also has the ability to obtain the second transmission information delivered by the network function entity at lower layer. When the second transmission information is obtained, the second configuration information is transmitted to the first network function entity instead of other network function entities based on the second indication information of the second transmission information, thereby standardizing data transmission.

With reference to some embodiments of the first aspect, in some embodiments, the second network function entity is a PDCP entity, and the second transmission information is a second PDCP PDU.

In combination with some embodiments of the first aspect, in some embodiments, the second network function entity is an RRC entity, and the second transmission information is a second RRC message.

In combination with some embodiments of the first aspect, in some embodiments, the wireless bearer corresponding to the PDCP entity that obtains the second transmission information is the same as the wireless bearer corresponding to the first network function entity or the wireless bearer corresponding to the second AI model.

In combination with some embodiments of the first aspect, in some embodiments, the radio bearer corresponding to the second RRC message is the same as the radio bearer corresponding to the first network function entity or the radio bearer corresponding to the second AI model.

In conjunction with some embodiments of the first aspect, in some embodiments, the second configuration information includes at least one of the following:
adding information indicating an additional AI model, where the adding information includes the additional AI model and a model identifier of the additional AI model;
modifying information indicating a modified AI model, where the modifying information includes a model identifier of the modified AI model and a modified model parameter; or
deleting information indicating a deleted AI model, where the deleting information includes a model identifier of the deleted AI model.

In a second aspect, an embodiment of the present disclosure provides a communication method, which is applied to a first network function entity, and the method includes:
delivering first configuration information downward to a second network function entity;
where the first network function entity and the second network function entity are network function entities of an access layer; and
the first configuration information is used to configure a first artificial intelligence (AI) model.

In combination with some embodiments of the second aspect, in some embodiments, the second network function entity is a PDCP entity or an RRCE entity.

In conjunction with some embodiments of the second aspect, in some embodiments, delivering the first configuration information to the second network function entity further includes:
obtaining, by the first network function entity, bearer information;
where the bearer information is used to indicate at least one of the following:
a radio bearer corresponding to the first network function entity; or
a radio bearer corresponding to the first AI model.

In conjunction with some embodiments of the second aspect, in some embodiments, the first configuration information includes at least one of the following:
adding information indicating an additional AI model, where the adding information includes the additional AI model and a model identifier of the additional AI model;
modifying information indicating a modified AI model, where the modifying information includes a model identifier of the modified AI model and a modified model parameter; or
deleting information indicating a deleted AI model, where the deleting information includes a model identifier of the deleted AI model.

In conjunction with some embodiments of the second aspect, in some embodiments, the method further includes:
obtaining second configuration information delivered upward by the second network function entity, where the second configuration information is used to configure a second AI model; and
configuring the second AI model based on the second configuration information.

In conjunction with some embodiments of the second aspect, in some embodiments, the second configuration information includes at least one of the following:
adding information indicating an additional AI model, where the adding information includes the additional AI model and a model identifier of the additional AI model;
modifying information indicating a modified AI model, where the modifying information includes a model identifier of the modified AI model and a modified model parameter; or
deleting information indicating a deleted AI model, where the deleting information includes a model identifier of the deleted AI model.

In a third aspect, an embodiment of the present disclosure provides a method applied to a second network function entity, the method including:
obtaining first configuration information delivered downward by a first network function entity;
where the first network function entity and the second network function entity are network function entities of an access layer; and
the first configuration information is used to configure a first artificial intelligence (AI) model.

In conjunction with some embodiments of the third aspect, in some embodiments, the method further includes:
determining first transmission information based on the first configuration information, and delivering the first transmission information downward to a network function entity at lower layer;
where the first transmission information includes the first configuration information and first indication information, and where the first indication information is used to indicate that the first transmission information carries information of the first network function entity.

In combination with some embodiments of the third aspect, in some embodiments, the second network function entity is a PDCP entity or an RRC entity.

With reference to some embodiments of the third aspect, in some embodiments, the second network function entity is the PDCP entity, and the first transmission information is a first packet data convergence protocol protocol data unit (PDCP PDU).

In combination with some embodiments of the third aspect, in some embodiments, the second network function entity is the RRC entity, and the first transmission information is a first RRC message.

In combination with some embodiments of the third aspect, in some embodiments, the wireless bearer corresponding to the PDCP entity that obtains the first configuration information is the same as the wireless bearer corresponding to the first network function entity or the wireless bearer corresponding to the first AI model.

In combination with some embodiments of the third aspect, in some embodiments, the radio bearer corresponding to the first RRC message is the same as the radio bearer corresponding to the first network function entity or the radio bearer corresponding to the first AI model.

In conjunction with some embodiments of the third aspect, in some embodiments, the first configuration information includes at least one of the following:
adding information indicating an additional AI model, where the adding information includes the additional AI model and a model identifier of the additional AI model;
modifying information indicating a modified AI model, where the modifying information includes a model identifier of the modified AI model and a modified model parameter; or
deleting information indicating a deleted AI model, where the deleting information includes a model identifier of the deleted AI model.

In conjunction with some embodiments of the third aspect, in some embodiments, the method further includes:
delivering second configuration information upward to the first network function entity, where the second configuration information is used to configure a second AI model; and
configuring, by the first network function entity, the second AI model based on the second configuration information.

In conjunction with some embodiments of the third aspect, in some embodiments, the delivering second configuration information upward to the first network function entity further includes:
obtaining second transmission information delivered upward by a network function entity at lower layer, where the second transmission information includes the second configuration information and second indication information, and the second indication information is used to indicate that the second transmission information carries information of the first network function entity.

With reference to some embodiments of the third aspect, in some embodiments, the second network function entity is a PDCP entity, and the second transmission information is a second PDCP PDU.

In combination with some embodiments of the third aspect, in some embodiments, the second network function entity is an RRC entity, and the second transmission information is a second RRC message.

In combination with some embodiments of the third aspect, in some embodiments, the wireless bearer corresponding to the PDCP entity that obtains the second transmission information is the same as the wireless bearer corresponding to the first network function entity or the wireless bearer corresponding to the second AI model.

In combination with some embodiments of the third aspect, in some embodiments, the radio bearer corresponding to the second RRC message is the same as the radio bearer corresponding to the first network function entity or the radio bearer corresponding to the second AI model.

In conjunction with some embodiments of the third aspect, in some embodiments, the second configuration information includes at least one of the following:
adding information indicating an additional AI model, where the adding information includes the additional AI model and a model identifier of the additional AI model;
modifying information indicating a modified AI model, where the modifying information includes a model identifier of the modified AI model and a modified model parameter; or
deleting information indicating a deleted AI model, where the deleting information includes a model identifier of the deleted AI model.

In a fourth aspect, an embodiment of the present disclosure provides a communication device, including:
a first delivering module, configured for a first network function entity of the communication device to deliver the first configuration information downward to a second network function entity;
where the first network function entity and the second network function entity are network function entities of an access layer; and
the first configuration information is used to configure a first artificial intelligence (AI) model.

In a fifth aspect, an embodiment of the present disclosure provides a first network function entity, including:
a second delivering module, configured to deliver the first configuration information downward to a second network function entity;
where the first network function entity and the second network function entity are network function entities of an access layer; and
the first configuration information is used to configure a first artificial intelligence (AI) model.

In a sixth aspect, an embodiment of the present disclosure provides a second network function entity, including:
a first obtaining module, configured to obtain first configuration information delivered downward by a first network function entity;
where the first network function entity and the second network function entity are network function entities of an access layer;
the first configuration information is used to configure a first artificial intelligence (AI) model.

In a seventh aspect, an embodiment of the present disclosure provides an electronic device including a memory, a processor, and a computer program stored in the memory, where the processor executes the computer program to implement the steps of the method described in any one of the first to third aspects above.

In an eighth aspect, an embodiment of the present disclosure provides a computer-readable storage medium having a computer program stored thereon, which implements the steps of the method described in any one of the first to third aspects above when the computer program is executed by a processor.

In some embodiments, terms such as communication method and information processing method can be replaced with each other, terms such as communication equipment and information processing device, communication device can be replaced with each other, and terms such as information processing system and communication system can be replaced with each other.

The embodiments of the present disclosure are not exhaustive and are merely illustrative of some embodiments, and are not intended to be a specific limitation on the scope of protection of the embodiment of the present disclosure. In the absence of contradiction, each step in a certain embodiment can be implemented as an independent embodiment, and the steps can be arbitrarily combined. For example, a solution after removing some steps in a certain embodiment can also be implemented as an independent embodiment, and the order of the steps in a certain embodiment can be arbitrarily exchanged. In addition, the optional implementation methods in a certain embodiment can be arbitrarily combined; in addition, the embodiments can be arbitrarily combined. For example, some or all steps of different embodiments can be arbitrarily combined, and a certain embodiment can be arbitrarily combined with the optional implementation methods of other embodiments.

In the respective embodiments of the present disclosure, unless otherwise specified or provided for by logic, the terms and/or descriptions between the embodiments are consistent and can be referenced by each other. The technical features in different embodiments can be combined to form a new embodiment based on their inherent logical relationships.

The terms used in the embodiments of the present disclosure are only for the purpose of describing specific embodiments and are not intended to limit the embodiment of the present disclosure.

In the embodiments of the present disclosure, unless otherwise specified, elements expressed in the singular, such as “a”, “an”, “the”, “above”, “said”, “foregoing”, “this”, etc., may mean “one and only one”, or “one or more”, “at least one”, etc. For example, when articles such as “a”, “an”, or “the” in English are used in translation, the noun following the article may be understood as a singular expression or a plural expression.

In the embodiments of the present disclosure, “plurality” refers to two or more. In some embodiments, the terms “at least one of”, “at least one of”, “at least one of”, “one or more”, “a plurality of”, “multiple”, etc. can be used interchangeably.

In the embodiments of the present disclosure, descriptions such as “at least one of A, B, C . . . ” , “A and/or B and/or C . . . ”, etc., include the case where any one of A, B, C . . . exists alone, and also include any combination of any multiple of A, B, C . . . , and each case can exist alone; for example, “at least one of A, B, C” includes the case of A alone, B alone, C alone, the combination of A and B, the combination of A and C, the combination of B and C, and the combination of A, B, and C; for example, A and/or B includes the case of A alone, B alone, and the combination of A and B.

In some embodiments, descriptions such as “in one case, A, in another case, B”, or “in response to one case, A, in response to another case, B”, can include the following technical solutions depending on the situation: executing A independently of B (in some embodiments, A); executing B independently of A (in some embodiments, B); selectively executing A and B (in some embodiments, selecting between A and B); and executing both A and B (in some embodiments, A and B). The above description also applies when there are multiple branches, such as A, B, and C.

The prefixes “first” and “second” in the embodiments of the present disclosure are only used to distinguish different description objects and do not constitute any restriction on the position, order, priority, quantity or content of the description objects. For the statement of the description object, please refer to the description in the context of the claims or embodiments, and no unnecessary restriction should be constituted due to the use of prefixes. For example, if the description object is a “field”, the ordinal number before the “field” in the “first field” and the “second field” does not limit the position or order between the “fields”. “First” and “second” do not limit whether the “fields” they modify are in the same message, nor do they limit the order of the “first field” and the “second field”. For another example, if the description object is a “level”, the ordinal number before the “level” in the “first level” and the “second level” does not limit the priority between the “levels”. For another example, the number of description objects is not limited by the ordinal number and can be one or more. Taking “first device” as an example, the number of “devices” can be one or more. In addition, the objects modified by different prefixes can be the same or different.

For example, if the description object is “device”, then the “first device” and the “second device” can be the same device or different devices, and their types can be the same or different; for another example, if the description object is “information”, then the “first information” and the “second information” can be the same information or different information, and their contents can be the same or different.

In some embodiments, “including A”, “comprising A”, “for indicating A”, and “carrying A” can be interpreted as directly carrying A or indirectly indicating A.

In some embodiments, terms such as “in response to . . . ” , “in response to determining . . . ”, “in the case of . . . ”, “at the time of . . . ”, “when . . . ”, “if . . . ”, “provided . . . ”, etc. can be used interchangeably.

In some embodiments, terms such as “greater than”, “greater than or equal to”, “not smaller than”, “more than”, “more than or equal to”, “not less than”, “higher than”, “higher than or equal to”, “not lower than”, and “above” can be replaced with each other, and terms such as “smaller than”, “smaller than or equal to”, “not greater than”, “less than”, “less than or equal to”, “not more than”, “lower than”, “lower than or equal to”, “not higher than”, and “below” can be replaced with each other.

In some embodiments, devices and the like can be interpreted as physical or virtual, and their names are not limited to the names described in the embodiments. Terms such as “apparatus”, “equipment”, “device”, “circuit”, “network element”, “node”, “function”, “unit”, “section”, “system”, “network”, “chip”, “chip system”, “entity”, and “subject” can be used interchangeably.

In some embodiments, the terms such as “access network device (AN device)”, “radio access network device (RAN device)”, “base station (BS)”, “radio base station”, “fixed station”, “node”, “access point”, “transmission point (TP)”, “reception point (RP)”, “transmission/reception point (TRP)”, “panel”, “antenna panel”, “antenna array”, “cell”, “macro cell”, “small cell”, “femto cell”, “pico cell”, “sector”, “cell group”, “carrier”, “component carrier” and “bandwidth part (BWP)” can be used interchangeably.

In some embodiments, the terms such as “terminal”, “terminal device”, “user equipment (UE)”, “user terminal”, “mobile station (MS)”, “mobile terminal (MT)”, subscriber station, mobile unit, subscriber unit, wireless unit, remote unit, mobile device, wireless device, wireless communication device, remote device, mobile subscriber station, access terminal, mobile terminal, wireless terminal, remote terminal, handset, user agent, mobile client, client may be used interchangeably.

In some embodiments, access network devices, core network devices, or network devices can be replaced with terminals. For example, structures in which the communication between an access network device, core network device, or network device and a terminal is replaced with communication between multiple terminals, which can also be referred to device-to-device (D2D) or vehicle-to-everything (V2X), can also be applied to the respective embodiment of the embodiments of the present disclosure. In this case, the terminal can also have all or part of the functionality of the access network device. Furthermore, terms such as “uplink” and “downlink” can be replaced with terms corresponding to inter-terminal communication (e.g., “sidelink”).

For example, uplink channels and downlink channels can be replaced with sidelink channels, and uplink and downlink can be replaced with sidelinks.

In some embodiments, the terminal may be replaced by an access network device, a core network device, or a network device. In this case, the access network device, the core network device, or the network device may have a structure that has all or part of the functions of the terminal.

In some embodiments, the names of information, etc. are not limited to the names described in the embodiments, and terms such as “information”, “message”, “signal”, “signaling”, “report”, “configuration”, “indication”, “instruction”, “command”, “channel”, “parameter”, “domain”, “field”, “symbol”, “symbol”, “code element”, “codebook”, “codeword”, “codepoint”, “bit”, “data”, “program”, and “chip” can be used interchangeably.

In some embodiments, terms such as “uplink”, “up link”, and “physical uplink” can be used interchangeably, terms such as “downlink”, “down link”, and “physical downlink” can be used interchangeably, and terms such as “side”, “sidelink”, “side communication”, “sidelink communication”, “direct connection”, “direct link”, “direct communication”, and “direct link communication” can be used interchangeably.

In some embodiments, the terms “downlink control information (DCI)”, “downlink (DL) assignment”, “DL DCI”, “uplink (UL) grant”, “UL DCI”, etc. may be used interchangeably.

In some embodiments, the terms “physical downlink shared channel (PDSCH)” and “DL data” may be used interchangeably, and the terms “physical uplink shared channel (PUSCH) ”and “UL data” may be used interchangeably.

In some embodiments, the terms “radio”, “wireless”, “radio access network (RAN)”, “access network (AN)”, “RAN-based” and the like may be used interchangeably.

In some embodiments, the terms “search space”, “search space set”, “search space configuration”, “search space set configuration”, “control resource set (CORESET)”, and “CORESET configuration” may be used interchangeably.

In some embodiments, the terms “synchronization signal (SS)”, “synchronization signal block (SSB)”, “reference signal (RS)”, “pilot”, and “pilot signal” may be used interchangeably.

In some embodiments, terms such as “moment”, “time point”, “time”, and “time position” can be used interchangeably, and terms such as “duration”, “period”, “time window”, “window”, and “time” can be used interchangeably.

In some embodiments, the terms “component carrier (CC)”, “cell”, “frequency carrier”, “carrier frequency”, etc. may be used interchangeably.

In some embodiments, the terms “resource block (RB)”, “physical resource block (PRB)”, “sub-carrier group (SCG)”, “resource element group (REG)”, “PRB pair”, “RB pair”, “resource element (RE)” and the like may be used interchangeably.

In some embodiments, terms such as wireless access scheme and waveform may be used interchangeably.

In some embodiments, the terms “precoding”, “precoder”, “weight”, “precoding weight”, “quasi-co-location (QCL)”, “transmission configuration indication (TCI) state”, “spatial relation”, “spatial domain filter”, “transmission power”, “phase rotation”, “antenna port”, “antenna port group”, “layer”, “the number of layers”, “rank”, “resource”, “resource set”, “resource group”, “beam”, “beam width”, “beam angular degree”, “antenna”, “antenna element,” and “panel” may be used interchangeably.

In some embodiments, the terms “frame”, “radio frame”, “subframe”, “slot”, “sub-slot”, “mini-slot”, “symbol”, “symbol”, “transmission time interval (TTI)” and the like may be used interchangeably.

In some embodiments, “acquire”, “get”, “obtain”, “receive”, “transmission”, “bidirectional transmission”, “send and/or receive” can be interchangeable, and can be interpreted as receiving from other entities, obtaining from protocols, obtaining by self-processing, autonomous implementation, etc.

In some embodiments, terms such as “send”, “transmit”, “report”, “deliver”, “transmission”, “bidirectional transmission”, “send and/or receive” can be used interchangeably.

In some embodiments, “predetermined” and “preset” can be interpreted as pre-specified in a protocol, etc., or can be interpreted as a pre-set action performed by a device, etc.

In some embodiments, determining can be interpreted as concluding, deciding, judging, calculating, computing, processing, deriving, investigating, retrieving, looking up, searching, inquiring, ascertaining, receiving, transmitting, input, output, accessing, resolving, selecting, choosing, establishing, comparing, “assuming”, “expecting”, “considering”, broadcasting, notifying, communicating, forwarding, configuring, reconfiguring, allocating, mapping, assigning, etc., but is not limited to.

In some embodiments, the determination or judgment can be performed by a value represented by 1 bit (0 or 1), or by a true or false value (Boolean value) represented by true or false, or by comparison of numerical values (for example, comparison with a predetermined value), but is not limited thereto.

In some embodiments, “network” can be interpreted as devices included in the network (e.g., access network equipment, core network equipment, etc.).

In some embodiments, “not expecting to receive” can be interpreted as not receiving on time and/or frequency domain resources, or as not performing subsequent processing on the data after receiving it. “not expecting to send” can be interpreted as not sending, or as sending but not expecting a response from the recipient.

In some embodiments, “existing”, “being stored”, and “stored” can be used interchangeably.

In some embodiments, obtaining data, information, etc. may comply with the laws and regulations of the country where the data is obtained.

In some embodiments, data, information, etc. may be obtained with the user's consent.

In addition, each element, each row, or each column in the table of the embodiment of the present disclosure can be implemented as an independent embodiment, and the combination of any elements, any rows, and any columns can also be implemented as an independent embodiment.

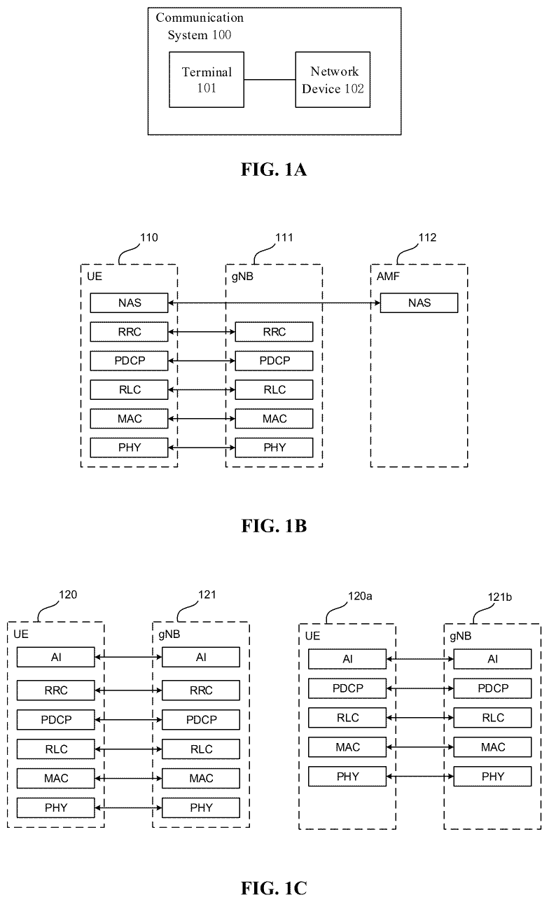

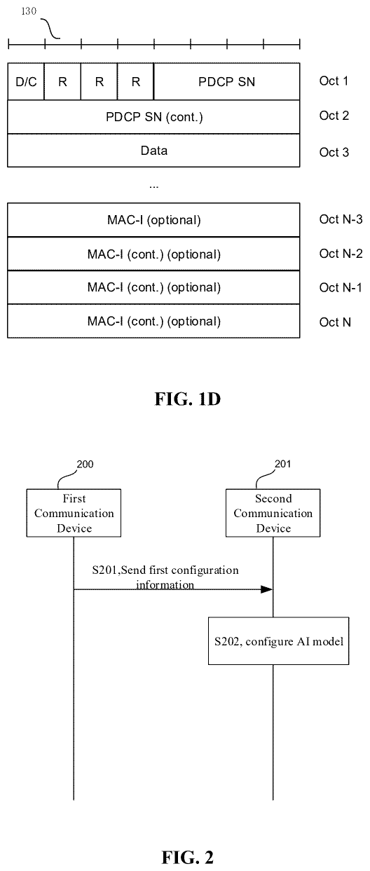

FIG. 1A is a schematic diagram showing the architecture of a communication system according to an embodiment of the present disclosure.

As shown in FIG. 1A, a communication system 100 includes a terminal 101 and a network device 102

In some embodiments, the terminal 101 includes, for example, at least one of a mobile phone, a wearable device, an Internet of Things device, a car with communication capabilities, a smart car, a tablet computer (Pad), a computer with wireless transceiver capabilities, a virtual reality (VR) terminal device, an augmented reality (AR) terminal device, a wireless terminal device in industrial control, a wireless terminal device in self-driving, a wireless terminal device in remote medical surgery, a wireless terminal device in a smart grid, a wireless terminal device in transportation safety, a wireless terminal device in a smart city, and a wireless terminal device in a smart home, but is not limited thereto.

In some embodiments, network device 102 may include an access network device.

In some embodiments, the access network device is, for example, a node or device that accesses a terminal to a wireless network. The access network device may include an evolved NodeB (eNB), a next generation evolved NodeB (ng-eNB), a next generation NodeB (gNB), a node B (NB), a home node B (HNB), a home evolved nodeB (HeNB), a wireless backhaul device, a radio network controller (RNC), a base station controller (BSC), a base transceiver station (BTS), a base band unit (BBU), a mobile switching center, a base station in a 6G communication system, an open base station (Open RAN), a cloud base station (Cloud RAN), a base station in other communication systems, and at least one of an access node in a wireless fidelity (WiFi) system, but is not limited thereto.

In some embodiments, the technical solution of the embodiment of the present disclosure can be applied to the Open RAN architecture. In this case, the interfaces between or within the network devices involved in the embodiments of the present disclosure can be transformed into internal interfaces of the Open RAN, and the processes and information interactions between these internal interfaces can be implemented through software or programs.

In some embodiments, the access network device may be formed of a centralized unit (CU) and a distributed unit (DU), where the CU may also be referred to as a control unit. A CU-DU structure may be used to separate the protocol layers of the network device, with some functions of the protocol layers centrally controlled by the CU and some or all functions of the remaining protocol layers distributed in the DU, which is centrally controlled by the CU, but is not limited thereto.

In some embodiments, the access network device may be a single device, or may be multiple devices or a group of devices, each including all or part of a first network element, a second network element, etc. The network element may be virtual or physical. The network device may include, for example, at least one of an Evolved Packet Core (EPC), a 5G Core Network (5GCN), or a Next Generation Core (NGC).

It can be understood that the communication system described in the embodiment of the present disclosure is for the purpose of more clearly illustrating the technical solution of the embodiment of the present disclosure, and does not constitute a limitation on the technical solution provided by the embodiment of the present disclosure. Those of ordinary skill in the art can know that with the evolution of the system architecture and the emergence of new service scenarios, the technical solution provided by the embodiment of the present disclosure is also applicable to similar technical problems.

The following embodiments of the present disclosure may be applied to the communication system 100 shown in FIG. 1A, or a portion thereof, but are not limited thereto. The entities shown in FIG. 1A are illustrative only. The communication system may include all or a portion of the entities shown in FIG. 1A, or may include other entities other than FIG. 1A. The number and configuration of the entities may be arbitrary. The connections between the entities are illustrative only. The entities may be connected or disconnected, and the connections may be in any manner, including direct or indirect, wired or wireless.

Embodiments of the respective embodiments of the present disclosure may be applied to Long Term Evolution (LTE), LTE-Advanced (LTE-A), LTE-Beyond (LTE-B), SUPER 3G, IMT-Advanced, 4th generation mobile communication system (4G), 5th generation mobile communication system (5G), 5G New Radio (NR), Future Radio Access (FRA), New Radio Access Technology (RAT), New Radio (NR), New Radio Access (NX), Future Generation Radio Access (FX), Global System for Mobile communications (GSM®), CDMA2000, Ultra Mobile Broadband (UMB), and the like. These standards include IEEE 802.11 (Wi-Fi®), IEEE 802.16 (WiMAX®), IEEE 802.20, ultra-wideband (UWB), Bluetooth®, public land mobile network (PLMN) networks, device-to-device (D2D) systems, machine-to-machine (M2M) systems, Internet of Things (IOT) systems, vehicle-to-everything (V2X), systems utilizing other communication methods, and next-generation systems based on and extending these methods. In addition, a combination of multiple systems (for example, a combination of LTE or LTE-A and 5G, etc.) can also be applied.

FIG. 1B is a hierarchical diagram of a control plane protocol stack in related art. As shown in the figure, the Non-Access-Stratum (NAS) includes the following network function entities in descending order:

Radio Resource Control (RRC) entity, Packet Data Convergence Protocol (PDCP) entity, Radio Link Control (RLC) entity, Media Access Control (MAC) entity and port physical layer (PHY) entity.

In related technologies, information used to configure the AI model is transmitted between core network devices, such as the Access and Mobility Management Function (AMF) 112, and the UE 110 through the NAS entity. Since this information does not pass through the access network device (such as the gNB 111 in FIG. 1B), the access network device cannot manage this information.

It should be understood that data is delivered downward to the network function entity at lower layer in the access layer of a communication device through various network function entities, and then transmitted by the network function entity at lower layer to the network function entity at lower layer of another communication device. Then, in the access layer of the other communication device, the data is delivered upward by the network function entity at lower layer. During the upward delivering process in the related technology, some network function entities may deliver data upward to the network function entity of the higher layer of the control plane protocol stack, or they may deliver data upward to the network function entity of the higher layer of the user plane protocol stack. The specific details can be determined based on actual circumstances. Taking the PDCP entity as an example, when the PDCP entity obtains data delivered upward by the RLC entity, it may deliver the data to the network function entity of the higher layer of the user plane protocol stack: the Service Data Adaptation Protocol (SDAP) entity, or it may deliver the data to the network function entity of the higher layer of the control plane protocol stack: the RRC entity. In the embodiment of the present disclosure, a first network function entity is added in the access layer. The first network function module entity as the top layer of the access layer. The next layer can be an RCC entity or a PDCP entity, as shown in FIG. 1C. In the figure, the first network function entity between the UE 120, 120a and the gNB 121, 121a is represented by AI. The embodiment of the present disclosure does not limit the name of the first network function entity.

For example, it can also be called an artificial intelligence entity, AI entity, AI model entity, etc. The PDCP entity of the embodiment of the present disclosure receives data sent by the Radio Resource Control (RRC) entity or the Service Data Adaptation Protocol (SDAP) entity, the PDCP entity determines the Packet Data Convergence Protocol Protocol Data Unit (PDCP PDU). The PDU structure is shown in FIG. 1D 130, where Data is the received data, October 1 and October 2 are the PDCP corresponding to the data, and D/C is used to indicate the PDCP PDU is control or data PDU. PDCP SN indicates the sequence number (SN) of the PDCP PDU. R is a reserved bit. MAC-I is a Message Authentication Code for Integrity.

Each PDCP entity is associated with a radio bearer, which is classified into a data radio bearer (DRB) and a signaling radio bearer (SRB). The data radio bearer (DRB) is connected to the SDAP of the user plane, and the signaling radio bearer (SRB) is connected to the radio resource control (RRC) of the control plane.

FIG. 2 is an interactive diagram of a communication method according to an embodiment of the present disclosure. As shown in the figure, the embodiment of the present disclosure relates to a communication method for a communication system 100. The method includes:

S201. A first communication device 200 sends first configuration information to a second communication device 201.

The communication system may include a first communication device and a second communication device. In some embodiments, the first communication device and the second communication device may be either a terminal 101 or a network device 102. When the first communication device is the terminal 101, the second communication device is the network device 102; when the first communication device is the network device 102, the second communication device is the terminal 101.

In some embodiments, the first configuration information is used to configure the AI model. When the second communication device receives the configuration information, the second communication device may configure the AI model based on the configuration information.

In some embodiments, the AI model is an AI model deployed by the first communication device, and may also be an AI model deployed by the second communication device. When the first communication device is the terminal 101, the second communication device is the network device 102, and the AI model configured by the first configuration information is deployed by the network device 102. When the first communication device is the network device 102, the second communication device is the terminal 101, and the AI model configured by the first configuration information is deployed by the terminal 101.

In some embodiments, an AI model is a model for providing AI network functions. AI network functions are network functions involving AI technology. A network function is a function implemented by a network function entity. An access network may include multiple network function entities and multiple network functions, where one network function entity may implement one or more network functions, and a network function may be implemented by one network function entity or multiple network function entities.

In some embodiments, the AI network function is at least one of a network function that performs AI processing through an AI model (also referred to as a neural network model) and a network function that outputs an AI model.

In the embodiment, the network function that performs AI processing through the AI model may exemplarily include at least one of the following: a network function that performs data processing on audio data through the AI model, a network function that performs data processing on video data through the AI model, a network function that performs data processing on text through the AI model, etc. In the embodiment, the network function that outputs the AI model may exemplarily include at least one of the following: a network function that outputs the AI model that performs AI processing on audio data, a network function that outputs the AI model that performs AI processing on video data, a network function that outputs the AI model that performs AI processing on text, etc. It should be understood that before performing AI processing through the AI model or outputting the AI model, the embodiments of the present disclosure may also train the AI model, so that AI processing can be performed through the trained AI model, or the trained AI model can be output.

In some embodiments, configuring the AI model may include at least one of adding an AI model, deleting/releasing an AI model, or modifying the AI model.

In some embodiments, the first configuration information may include adding information indicating an additional AI model, where the adding information includes the additional AI model and a model identifier of the additional AI model.

In some embodiments, the first configuration information may include modifying information indicating a modified AI model, where the modifying information includes a model identifier of the modified AI model and modified model parameters.

In some embodiments, the first configuration information may include deleting information indicating a deleted AI model, where the deletion information includes a model identifier of the deleted AI model.

The network function entities included in the access layer of the communication device according to the present disclosure, as well as the hierarchical relationships between the network function entities, are configured by the protocol stack. When an upper-layer network function entity delivers information to a lower-layer network function entity, this is called downward delivery. Similarly, when a lower-layer network function entity delivers information to an upper-layer network function entity, this is called upward delivery. For example, the PDCP entity is located above the RLC entity, so when a PDCP entity delivers information to an RLC entity, this is called downward delivery, and when an RLC entity delivers information to a PDCP entity, this is called upward delivery.

In some embodiments, the access layer includes a first network function entity, which is the top layer of the control plane protocol stack, and the first network function entity is used to configure the AI model.

In some embodiments, the first communication device obtains the first configuration information through the first network function entity.

In some embodiments, the first network function entity obtains bearer information, where the bearer information indicates a radio bearer corresponding to the first network function entity and/or a radio bearer corresponding to an AI model configured by the first configuration information. For example, the bearer information indicates that the radio bearer corresponding to the first network function entity is radio bearer 1, and the first network function entity delivers the first configuration information to a PDCP entity corresponding to radio bearer 1.

In some embodiments, the bearer information is determined by the access network device 102.

When the first communication device is a terminal, the first network function entity of the first communication device obtains the bearer information delivered by the access network device 102.

In some embodiments, the first network function entity delivers the first configuration information downward to the second network function entity, the second network function entity determines the first transmission information based on the first configuration information, and delivers the first transmission information downward so that the next layer network function entity of the second network function entity transmits the first transmission information to the second communication device.

In some embodiments, the second network function entity may be a PDCP entity.

When the second network function entity is a PDCP entity, when the first network function entity delivers the first configuration information downward, the first configuration information may be delivered to the first PDCP entity corresponding to the radio bearer.

In some embodiments, the radio bearer corresponding to the first PDCP entity is a radio bearer corresponding to the first network function entity.

In some embodiments, the radio bearer corresponding to the first PDCP entity is a radio bearer corresponding to the first AI model.

When the second network function entity is a PDCP entity, the first transmission information is a first packet data convergence protocol protocol data unit (PDCP PDU).

In some embodiments, the first PDCP PDU includes first configuration information and first indication information.

In some embodiments, the first indication information is used to indicate that the first PDCP PDU carries information of the first network function entity. Thus, when the PDCP entity of the second communication device obtains the first PDCP PDU, it determines to deliver the first PDCP PDU to the first network function entity instead of SDAP or RRC based on the first indication information.

In some embodiments, the first indication information is stored in one or more reserved bits in oct1 of the PDCP PDU.

In some embodiments, the PDCP entity delivers the first transmission information, i.e., the first PDCP PDU, downward to the RLC entity of the first communication device. In the embodiments of the present disclosure, one RLC entity corresponds to one radio bearer. The PDCP entity delivers the PDCP PDU to the RLC entity corresponding to the radio bearer of the PDCP entity itself.

In some embodiments, when the radio bearer corresponding to the PDCP entity is the radio bearer corresponding to the first network function entity, the radio bearer corresponding to the RLC entity to which the PDCP delivers the first PDCP PDU downward is also the radio bearer corresponding to the first network function entity.

In some embodiments, when the radio bearer corresponding to the PDCP entity is a radio bearer corresponding to the configured AI model, the radio bearer corresponding to the RLC entity to which the PDCP delivers the first PDCP PDU downward is also the radio bearer corresponding to the configured AI model.

In some embodiments, the first transmission information is delivered downward to the network function entity at lower layer, which then delivers the first transmission information to the network function entity at lower layer of the second communication device.

In some embodiments, the network function entity at lower layer of the access layer is determined by the protocol stack. Taking the second network function entity as a PDCP as an example, the network function entity at lower layer can be an RLC network function entity, a MAC network function entity, or a PHY network function entity. To facilitate the description of the communication process, various embodiments of the present disclosure use the network function entity of the next layer below the second network function entity as the network function entity at lower layer. For example, when the second network function entity is a PDCP entity, the lower layer is an RLC entity. Therefore, the RLC entity of the first communication device delivers the first PDCP PDU to the RLC entity of the second communication device.

In some embodiments, the RLC entity of the first communication device determines a first RLC PDU based on the first PDCP PDU, the first RLC PDU including the first PDCP PDU, and the RLC entity of the first communication device sends the first RLC PDU to the RLC entity of the second communication device.

In some embodiments, the second network function entity may be an RRC entity, that is, the first network function entity delivers the first configuration information downward to the RRC entity. When the second network function entity is an RRC entity, the first transmission information is a first RRC message.

In some embodiments, the first RRC message includes first configuration information and second indication information.

In some embodiments, the second indication information is used to indicate that the first RRC message carries information of the first network function entity. Thus, when the RRC entity of the second communication device obtains the first RRC message, it determines to deliver the first RRC message to the first network function entity based on the first indication information.

In some embodiments, the radio bearer corresponding to the first RRC message is a radio bearer corresponding to the first network function entity.

In some embodiments, the radio bearer corresponding to the first RRC message is a radio bearer corresponding to the first AI model.

In some embodiments, the RRC entity delivers the first RRC message downward to the PDCP entity of the first communications device. It should be understood that the radio bearer of the first RRC message is the same as the radio bearer of the PDCP entity delivered downward.

In some embodiments, the PDCP entity of the first communication device determines a new PDCP PDU based on the first RRC message, and delivers the new PDCP PDU to the PDCP entity of the second communication device corresponding to the radio bearer, with the first RRC message serving as data of the new PDCP PDU. S202. The second communication device configures a first AI model.

In one embodiment, when the second network function entity is a PDCP entity, the RLC entity of the second communication device obtains a first RLC PDU delivered by the RLC entity of the first communication device, where the first RLC PDU includes a first PDCP PDU.

In some embodiments, one RLC entity corresponds to one radio bearer, so the RLC entity of the first communication device delivers the first RLC PDU to the RLC entity of the second communication device corresponding to the same radio bearer.

In some embodiments, the RLC entity of the second communications device delivers the first PDCP PDU in the first RLC PDU to the PDCP entity of the second communications device.

In some embodiments, one RLC entity corresponds to one radio bearer, and accordingly, the RLC entity of the second communication device delivers the first PDCP PDU to the PDCP entity of the second communication device corresponding to the same radio bearer.

The PDCP entity of the second communication device delivers the first configuration information to the first network function entity of the second communication device.

In some embodiments, the PDCP entity of the second communication device determines, based on the first indication information in the first PDCP PDU, that the first PDCP PDU needs to be delivered to the first network function entity of the second communication device, instead of SDAP or RRC, and delivers the first configuration information to the first network function entity of the second communication device.

In one embodiment, when the second network function entity is an RRC entity, the PDCP entity of the first communication device delivers the new PDCP PDU to the PDCP entity of the second communication device.

In one embodiment, when the second network function entity is an RRC, the PDCP entity of the second communication device delivers the first RRC message in the new PDCP PDU upward to the RRC entity. The RRC entity delivers the first configuration information to the first network function entity based on the second indication information in the first RRC message.

The first network function entity of the second communication device configures the AI model based on the first configuration information.

In some embodiments, configuring the AI model may include at least one of adding an AI model, deleting/releasing an AI model, or modifying the AI model.

In some embodiments, the first configuration information may include adding information indicating an additional AI model, where the adding information includes the additional AI model and a model identifier of the additional AI model. The first network function entity of the second communication device deploys the additional AI model and stores the model identifier of the additional AI model based on the adding information.

In some embodiments, the first configuration information may include modifying information indicating a modified AI model, where the modifying information includes a model identifier of the modified AI model and modified model parameters. The first network function entity of the second communication device determines the modified AI model based on the model identifier of the modified AI model in the modifying information, and then updates the modified AI model based on the modified model parameters to obtain an updated AI model.

In some embodiments, the first configuration information may include deleting information for indicating a deleted AI model, where the deleting information includes a model identifier of the deleted AI model. The first network function entity of the second communication device deletes the AI model indicated by the deleting information based on the deletion information.

The communication method involved in the embodiment of the present disclosure may include at least one of steps S201 to S202. For example, step S201 may be implemented as a separate embodiment, and step S202 may be implemented as a separate embodiment, but is not limited thereto.

In some embodiments, steps S201 and S202 may be performed in an interchangeable order or simultaneously.

In some embodiments, step S201 is optional, and one or more of these steps may be omitted or replaced in different embodiments.

In some embodiments, step S202 is optional, and one or more of these steps may be omitted or replaced in different embodiments.

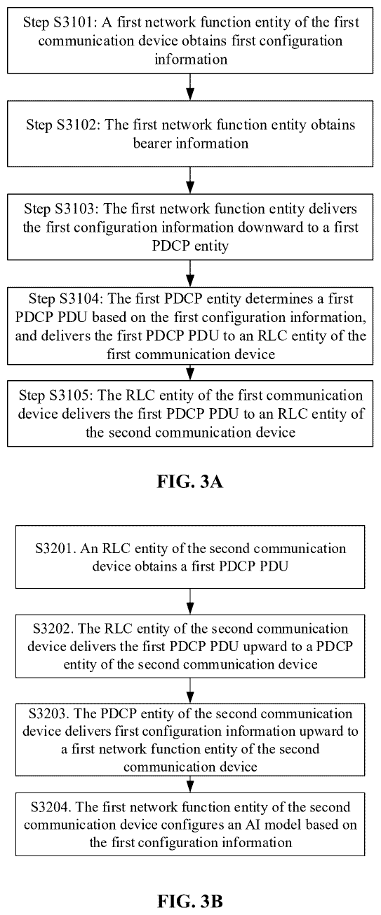

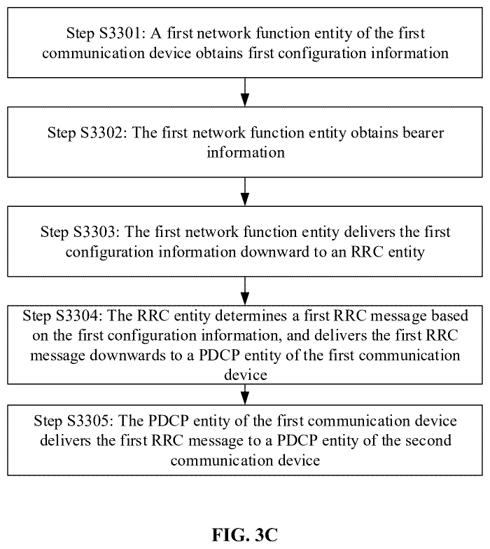

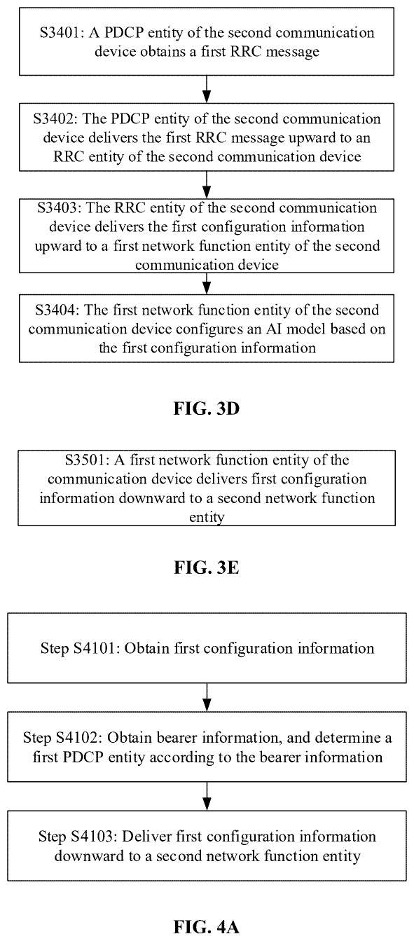

FIG. 3A is a flow chart of a communication method according to an embodiment of the present disclosure. As shown in FIG. 3A, the communication method according to the embodiment of the present disclosure is performed by a first communication device. The method includes:

Step S3101: A first network function entity of the first communication device obtains first configuration information.

In some embodiments, optional implementations of step S3101 can refer to the optional implementations of step S201 in FIG. 2 and other related parts in the embodiment involved in FIG. 2, which will not be described in detail here.

In some embodiments, the first network function entity of the first communication device receives first configuration information specified by a protocol.

In some embodiments, the first network function entity of the first communication device obtains the first configuration information from a higher layer.

In some embodiments, the first network function entity of the first communication device performs processing to obtain the first configuration information.

In some embodiments, step S3101 is omitted, and the first communication device autonomously implements the function indicated by the first configuration information, or the above function is default or by default.

Step S3102: The first network function entity obtains bearer information.

In some embodiments, optional implementations of step S3102 can refer to the optional implementations of step S201 in FIG. 2 and other related parts in the embodiment involved in FIG. 2, which will not be described in detail here.

In some embodiments, the first network function entity of the first communication device receives bearer information specified by a protocol.

In some embodiments, the first network function entity of the first communication device obtains the bearer information from a higher layer.

In some embodiments, the first network function entity of the first communication device performs processing to obtain the bearer information.

In some embodiments, step S3102 is omitted, and the first communication device autonomously implements the function indicated by the bearer information, or the above function is default or by default.

Step S3103: The first network function entity delivers the first configuration information downward to a first PDCP entity.

In some embodiments, optional implementations of step S3103 can refer to the optional implementations of step S201 in FIG. 2 and other related parts in the embodiment involved in FIG. 2, which will not be described in detail here.

Step S3104: The first PDCP entity determines a first PDCP PDU based on the first configuration information, and delivers the first PDCP PDU to an RLC entity of the first communication device. In some embodiments, optional implementations of step S3104 can refer to the optional implementations of step S201 in FIG. 2 and other related parts in the embodiment involved in FIG. 2, which will not be described in detail here.

Step S3105: The RLC entity of the first communication device delivers the first PDCP PDU to an RLC entity of the second communication device.

In some embodiments, optional implementations of step S3105 can refer to the optional implementations of step S201 in FIG. 2 and other related parts in the embodiment involved in FIG. 2, which will not be described in detail here.

The communication method involved in the embodiment of the present disclosure may include at least one of steps S3101 to S3105. For example, step S3101 can be implemented as an independent embodiment, step S3104 can be implemented as an independent embodiment, step S3101 and step S3104 can be implemented as independent embodiments, and step S3101, step S3104, and step S3105 can be implemented as independent embodiments, but are not limited thereto.

In some embodiments, steps S3101 and S3102 may be performed in an interchangeable order or simultaneously.

In some embodiments, steps S3102 and S3105 are optional, and one or more of these steps may be omitted or replaced in different embodiments.

In some embodiments, the first configuration information is used to configure an AI model for the first network function entity of the second communication device. For optional implementations, see the optional implementations of step S202 in FIG. 2 and other related parts of the embodiment involved in FIG. 2, which will not be described in detail here.

FIG. 3B is a flow chart of a communication method according to an embodiment of the present disclosure. As shown in FIG. 3B, the communication method according to the embodiment of the present disclosure is performed by a second communication device. The method includes:

S3201. An RLC entity of the second communication device obtains a first PDCP PDU.

In some embodiments, optional implementations of step S3201 can refer to the optional implementations of step S202 in FIG. 2 and other related parts in the embodiment involved in FIG. 2, which will not be described in detail here.

S3202. The RLC entity of the second communication device delivers the first PDCP PDU upward to a PDCP entity of the second communication device.

In some embodiments, optional implementations of step S3202 can refer to the optional implementation of step S202 in FIG. 2 and other related parts in the embodiment involved in FIG. 2, which will not be repeated here.

S3203. The PDCP entity of the second communication device delivers first configuration information upward to a first network function entity of the second communication device.

In some embodiments, optional implementations of step S3203 can refer to the optional implementations of step S202 in FIG. 2 and other related parts in the embodiment involved in FIG. 2, which will not be described in detail here.

S3204. The first network function entity of the second communication device configures an AI model based on the first configuration information.

In some embodiments, optional implementations of step S3204 can refer to the optional implementations of step S202 in FIG. 2 and other related parts in the embodiment involved in FIG. 2, which will not be described in detail here.

The communication method involved in the embodiments of the present disclosure may include at least one of steps S3201 to S3204. For example, step S3201 can be implemented as an independent embodiment, step S3203 can be implemented as an independent embodiment, step S3201 and step S3203 can be implemented as independent embodiments, and steps S3201, S3203, and S3204 can be implemented as independent embodiments, but are not limited thereto.

In some embodiments, steps S3201 and S3202 may be performed in an interchangeable order or simultaneously.

In some embodiments, step S3204 is optional, and one or more of these steps may be omitted or replaced in different embodiments.

FIG. 3C is a flow chart of a communication method according to an embodiment of the present disclosure. As shown in FIG. 3C, the communication method according to the embodiment of the present disclosure is performed by a first communication device. The method includes:

Step S3301: A first network function entity of the first communication device obtains first configuration information.

In some embodiments, the optional implementation methods of step S3301 can refer to the optional implementation methods of step S201 in FIG. 2 and other related parts in the embodiment involved in FIG. 2, and can also refer to the optional implementation methods of step S3101 in FIG. 3A and other related parts in the embodiment involved in FIG. 3A, which will not be repeated here.

Step S3302: The first network function entity obtains bearer information.

In some embodiments, the optional implementation methods of step S3302 can refer to the optional implementation methods of step S201 in FIG. 2 and other related parts in the embodiment involved in FIG. 2, and can also refer to the optional implementation methods of step S3102 in FIG. 3A and other related parts in the embodiment involved in FIG. 3A, which will not be repeated here.

Step S3303: The first network function entity delivers the first configuration information downward to an RRC entity.

In some embodiments, optional implementations of step S3303 may refer to the optional implementations of step S201 in FIG. 2 and other related parts in the embodiment involved in FIG. 2.

Step S3304: The RRC entity determines a first RRC message based on the first configuration information, and delivers the first RRC message downwards to a PDCP entity of the first communication device.

In some embodiments, optional implementations of step S3304 may refer to the optional implementations of step S201 in FIG. 2 and other related parts in the embodiments involved in FIG. 2.

Step S3305: The PDCP entity of the first communication device delivers the first RRC message to a PDCP entity of the second communication device.

In some embodiments, optional implementations of step S3305 may refer to the optional implementations of step S201 in FIG. 2 and other related parts in the embodiments involved in FIG. 2.

The communication method involved in the embodiments of the present disclosure may include at least one of steps S3301 to S3305. For example, step S3301 can be implemented as an independent embodiment, step S3304 can be implemented as an independent embodiment, step S3301 and step S3304 can be implemented as independent embodiments, and step S3301, step S3304, and step S3305 can be implemented as independent embodiments, but are not limited thereto.

In some embodiments, steps S3301 and S3302 may be performed in an interchangeable order or simultaneously.

In some embodiments, steps S3302 and S3305 are optional, and one or more of these steps may be omitted or replaced in different embodiments.

In some embodiments, the first configuration information is used to configure an AI model for the first network function entity of the second communication device. For optional implementations, see the optional implementations of step S202 in FIG. 2 and other related parts of the embodiment involved in FIG. 2, which will not be described in detail here.

FIG. 3D is a flow chart of a communication method according to an embodiment of the present disclosure. As shown in FIG. 3D, the communication method according to the embodiment of the present disclosure is performed by a second communication device. The method includes:

S3401: A PDCP entity of the second communication device obtains a first RRC message.

In some embodiments, optional implementations of step S3401 can refer to the optional implementations of step S202 in FIG. 2 and other related parts in the embodiment involved in FIG. 2, which will not be described in detail here.

S3402: The PDCP entity of the second communication device delivers the first RRC message upward to an RRC entity of the second communication device.

In some embodiments, optional implementations of step S3402 can refer to the optional implementations of step S202 in FIG. 2 and other related parts in the embodiment involved in FIG. 2, which will not be described in detail here.

S3403: The RRC entity of the second communication device delivers the first configuration information upward to a first network function entity of the second communication device.

In some embodiments, optional implementations of step S3403 can refer to the optional implementations of step S202 in FIG. 2 and other related parts in the embodiment involved in FIG. 2, which will not be described in detail here.

S3404: The first network function entity of the second communication device configures an AI model based on the first configuration information.

In some embodiments, optional implementations of step S3404 can refer to the optional implementations of step S202 in FIG. 2 and other related parts in the embodiment involved in FIG. 2, which will not be described in detail here.

The communication method involved in the embodiments of the present disclosure may include at least one of steps S3401 to S3404. For example, step S3401 can be implemented as an independent embodiment, step S3403 can be implemented as an independent embodiment, step S3401 and step S3403 can be implemented as independent embodiments, and steps S3401, S3403, and S3404 can be implemented as independent embodiments, but are not limited thereto.

In some embodiments, steps S3401 and S3402 may be performed in an interchangeable order or simultaneously.

In some embodiments, step S3404 is optional, and one or more of these steps may be omitted or replaced in different embodiments.

FIG. 3E is a flow chart of a communication method according to an embodiment of the present disclosure. As shown in FIG. 3E, the communication method according to the embodiment of the present disclosure is executed by a communication device. The method includes:

S3501: A first network function entity of the communication device delivers first configuration information downward to a second network function entity.

In some embodiments, optional implementations of step S3501 can refer to the optional implementations of step S201 in FIG. 2 and other related parts in the embodiment involved in FIG. 2, which will not be repeated here.

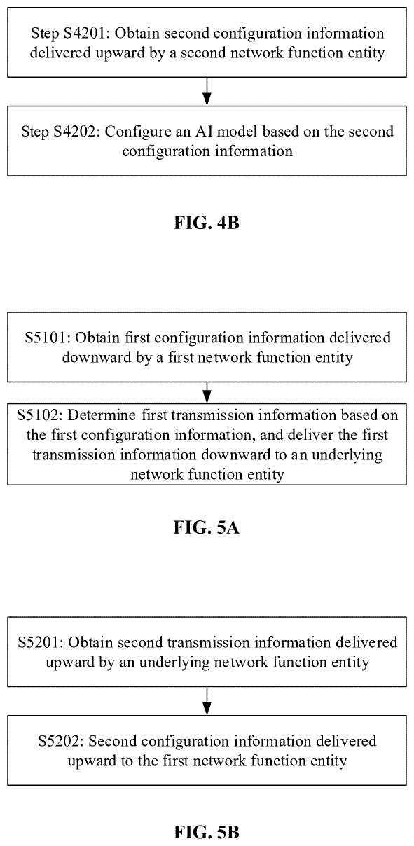

FIG. 4A is a flow chart of a communication method according to an embodiment of the present disclosure. As shown in FIG. 4A, the communication method involved in the embodiment of the present disclosure is performed by a first network function entity. The method includes:

Step S4101: Obtain first configuration information.

In some embodiments, the optional implementation methods of step S4101 can refer to the optional implementation methods of step S201 in FIG. 2 and other related parts in the embodiment involved in FIG. 2, and can also refer to the optional implementation methods of step S3101 in FIG. 3A and other related parts in the embodiment involved in FIG. 3A, which will not be repeated here.

Step S4102: Obtain bearer information, and determine a first PDCP entity based on the bearer information.

In some embodiments, the optional implementation methods of step S4102 can refer to the optional implementation methods of step S201 in FIG. 2 and other related parts in the embodiment involved in FIG. 2, and can also refer to the optional implementation methods of step S3102 in FIG. 3A and other related parts in the embodiment involved in FIG. 3A, which will not be repeated here.

Step S4103: Deliver first configuration information downward to a second network function entity. In some embodiments, the optional implementation methods of step S4103 can refer to the optional implementation methods of step S201 in FIG. 2 and other related parts in the embodiment involved in FIG. 2, and can also refer to the optional implementation methods of step S3103 in FIG. 3A and other related parts in the embodiment involved in FIG. 3A, and can also refer to the optional implementation methods of step S3303 in FIG. 3C and other related parts in the embodiment involved in FIG. 3C, which will not be repeated here.

The communication method involved in the embodiments of the present disclosure may include at least one of steps S4101 to S4103. For example, step S4101 can be implemented as an independent embodiment, step S4102 can be implemented as an independent embodiment, step S4101 and step S4103 can be implemented as independent embodiments, and step S4101, step S4102, and step S4103 can be implemented as independent embodiments, but are not limited thereto.

In some embodiments, steps S4101 and S4102 may be performed in an interchangeable order or simultaneously.

In some embodiments, steps S4102 and S4103 are optional, and one or more of these steps may be omitted or replaced in different embodiments.

In some embodiments, the first configuration information is used to configure an AI model for the first network function entity of the second communication device. For optional implementations, see the optional implementations of step S202 in FIG. 2 and other related parts of the embodiment involved in FIG. 2, which will not be described in detail here.

FIG. 4B is a flow chart of a communication method according to an embodiment of the present disclosure. As shown in FIG. 4B, the communication method involved in the embodiment of the present disclosure is performed by a first network function entity. The method includes:

Step S4201: Obtain second configuration information delivered upward by a second network function entity.

In some embodiments, the optional implementation methods of step S4201 can refer to the optional implementation methods of step S202 in FIG. 2 and other related parts in the embodiment involved in FIG. 2, and can also refer to the optional implementation methods of step S3203 in FIG. 3B and other related parts in the embodiment involved in FIG. 3B, and can also refer to the optional implementation methods of step S3403 in FIG. 3D and other related parts in the embodiment involved in FIG. 3D, which will not be repeated here.

Step S4202: Configure an AI model based on the second configuration information.

In some embodiments, the optional implementation methods of step S4201 can refer to the optional implementation methods of step S202 in FIG. 2 and other related parts in the embodiment involved in FIG. 2, and can also refer to the optional implementation methods of step S3204 in FIG. 3B and other related parts in the embodiment involved in FIG. 3B, and can also refer to the optional implementation methods of step S3404 in FIG. 3D and other related parts in the embodiment involved in FIG. 3D, which will not be repeated here.

The communication method involved in the embodiments of the present disclosure may include at least one of steps S4201 to S4202. For example, step S4201 may be implemented as an independent embodiment, step S4202 may be implemented as an independent embodiment, and steps S4101 and S4102 may be implemented as independent embodiments, but are not limited thereto.

In some embodiments, steps S4201 and S4202 may be performed in an interchangeable order or simultaneously.

In some embodiments, steps S4201 and S4202 are optional, and one or more of these steps may be omitted or replaced in different embodiments.

In some embodiments, the first configuration information is used to configure an AI model for the first network function entity of the second communication device. For optional implementations, see the optional implementations of step S202 in FIG. 2 and other related parts of the embodiment involved in FIG. 2, which will not be described in detail here.

FIG. 5A is a flow chart of a communication method according to an embodiment of the present disclosure. As shown in FIG. 5A, the communication method involved in the embodiment of the present disclosure is performed by a second network function entity. The method includes:

S5101: Obtain first configuration information delivered downward by a first network function entity.

In some embodiments, the optional implementation methods of step S5101 can refer to the optional implementation methods of step S201 in FIG. 2 and other related parts in the embodiment involved in FIG. 2, and can also refer to the optional implementation methods of step S3103 in FIG. 3A and other related parts in the embodiment involved in FIG. 3A, and can also refer to the optional implementation methods of step S3303 in FIG. 3C and other related parts in the embodiment involved in FIG. 3C, which will not be repeated here.

S5102: Determine first transmission information based on the first configuration information, and deliver the first transmission information downward to a network function entity at lower layer.

In some embodiments, the optional implementation methods of step S5102 can refer to the optional implementation methods of step S201 in FIG. 2 and other related parts in the embodiment involved in FIG. 2, and can also refer to the optional implementation methods of step S3104 in FIG. 3A and other related parts in the embodiment involved in FIG. 3A, and can also refer to the optional implementation methods of step S3304 in FIG. 3C and other related parts in the embodiment involved in FIG. 3C, which will not be repeated here.

In some embodiments, steps S5101 and S5102 may be performed in an interchangeable order or simultaneously.

In some embodiments, steps S5101 and S5102 are optional, and one or more of these steps may be omitted or replaced in different embodiments.

In some embodiments, the first configuration information is used to configure an AI model for the first network function entity of the second communication device. For optional implementations, see the optional implementations of step S202 in FIG. 2 and other related parts of the embodiment involved in FIG. 2, which will not be described in detail here.

FIG. 5B is a flow chart of a communication method according to an embodiment of the present disclosure. As shown in FIG. 5A, the communication method involved in the embodiment of the present disclosure is performed by a second network function entity. The method includes:

S5201: Obtain second transmission information delivered upward by a network function entity at lower layer.

In some embodiments, the optional implementation methods of step S5201 can refer to the optional implementation methods of step S202 in FIG. 2 and other related parts in the embodiment involved in FIG. 2, and can also refer to the optional implementation methods of step S3202 in FIG. 3B and other related parts in the embodiment involved in FIG. 3B, and can also refer to the optional implementation methods of step S3402 in FIG. 3D and other related parts in the embodiment involved in FIG. 3D, which will not be repeated here.

S5202: Deliver second configuration information upward to a first network function entity.

In some embodiments, the optional implementation methods of step S5202 can refer to the optional implementation method of step S202 in FIG. 2 and other related parts in the embodiment involved in FIG. 2, and can also refer to the optional implementation method of step S3203 in FIG. 3B and other related parts in the embodiment involved in FIG. 3B, and can also refer to the optional implementation method of step S3403 in FIG. 3D and other related parts in the embodiment involved in FIG. 3D, which will not be repeated here.

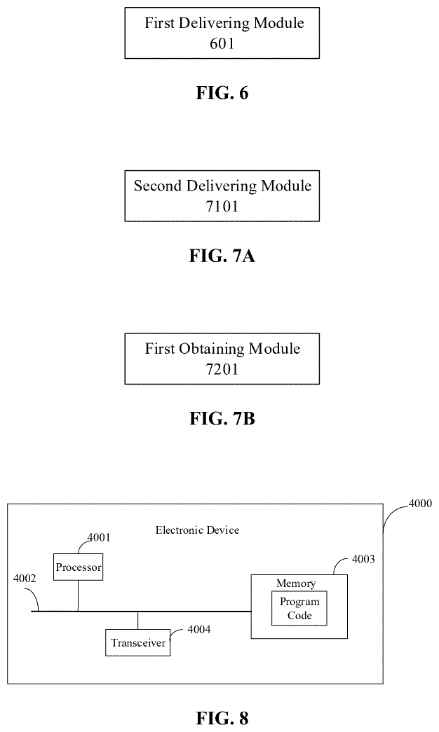

The embodiment of the present disclosure provides a communication device, as shown in FIG. 6, the communication device may include: a first delivering module 601.

The first delivering module 601 is configured for a first network function entity of a communication device to deliver first configuration information downward to a second network function entity.

The first network function entity and the second network function entity are network function entities of the access layer;

The first configuration information is used to configure a first artificial intelligence (AI) model.

Optionally, the first delivering module is configured to execute the steps related to sending the first configuration information performed by the network device in any of the above methods, which are not described in detail here. Optionally, the communication device may further include a configuring module, which is configured to execute the steps related to configuring the AI model performed by the network device in any of the above methods.

The network device of the embodiment of the present disclosure can execute the method provided by the embodiment of the present disclosure, and the implementation principles are similar. The actions performed by each module in the network device of each embodiment of the present disclosure correspond to the steps in the method of each embodiment of the present disclosure. For the detailed functional description of each module of the device, please refer to the description in the corresponding method shown above, and will not be repeated here.

The embodiment of the present disclosure provides a first network function entity, as shown in FIG. 7A, the communication device may include: a second delivering module 7101.

The second delivering module 7101 is configured to deliver the first configuration information downward to the second network function entity.

The first network function entity and the second network function entity are network function entities of the access layer.

The first configuration information is used to configure a first artificial intelligence (AI) model. The first network function entity of the embodiment of the present disclosure can execute the method provided by the embodiment of the present disclosure, and its implementation principle is similar. The actions performed by each module in the first network function entity of each embodiment of the present disclosure correspond to the steps in the method of each embodiment of the present disclosure. For the detailed functional description of each module of the device, please refer to the description in the corresponding method shown in the previous text, and will not be repeated here.

The embodiment of the present disclosure provides a second network function entity, as shown in FIG. 7B, the communication device may include: a first obtaining module 7201.

The first obtaining module 7201 is configured to obtain first configuration information delivered downward by a first network function entity.

The first network function entity and the second network function entity are network function entities of the access layer.

The first configuration information is used to configure a first artificial intelligence (AI) model.

The second network function entity of the embodiment of the present disclosure can execute the method provided by the embodiment of the present disclosure, and its implementation principle is similar. The actions performed by each module in the second network function entity of each embodiment of the present disclosure correspond to the steps in the method of each embodiment of the present disclosure. For the detailed functional description of each module of the device, please refer to the description of the corresponding method shown in the previous text, and will not be repeated here.

The embodiment of the present disclosure provides an electronic device, including a memory, a processor, and a computer program stored in the memory. The processor executes the above-mentioned computer program to implement the steps of the communication method. Compared with the related art, it can achieve: transmitting the AI model at the access layer, which can be used for the wireless communication system management process in 3GPP, laying the foundation for managing AI model at the access network device.

In an optional embodiment, an electronic device is further provided, as shown in FIG. 8, the electronic device 4000 shown in FIG. 8 includes: a processor 4001 and a memory 4003. The processor 4001 and the memory 4003 are connected, e.g., through a bus 4002. Optionally, the electronic device 4000 may further include a transceiver 4004, which may be used for data interaction between the electronic device and other electronic devices, such as data transmission and/or data reception. It should be noted that in actual applications, the transceiver 4004 is not limited to one, and the structure of the electronic device 4000 does not constitute a limitation on the embodiment of the present disclosure.

The processor 4001 may be a CPU (Central Processing Unit), a general-purpose processor, a DSP (Digital Signal Processor), an ASIC (Application Specific Integrated Circuit), an FPGA (Field Programmable Gate Array) or other programmable logic devices, transistor logic devices, hardware components or any combination thereof. It may implement or execute various exemplary logic blocks, modules and circuits described in conjunction with the disclosure of the present invention. The processor 4001 may also be a combination that implements computing functions, such as a combination of one or more microprocessors, a combination of a DSP and a microprocessor, or the like.

The bus 4002 may include a path for transmitting information between the above components. The bus 4002 may be a PCI (Peripheral Component Interconnect) bus or an EISA (Extended Industry Standard Architecture) bus, or the like. The bus 4002 may be divided into an address bus, a data bus, a control bus, and the like. For ease of representation, FIG. 8 only uses one thick line, but does not mean that there is only one bus or one type of bus.

The memory 4003 may be a ROM (Read Only Memory) or other types of static storage devices that can store static information and instructions, a RAM (Random Access Memory) or other types of dynamic storage devices that can store information and instructions, or an EEPROM (Electrically Erasable Programmable Read Only Memory), a CD-ROM (Compact Disc Read Only Memory) or other optical disk storage, optical disk storage (including compressed optical disk, laser disk, optical disk, digital versatile disk, Blu-ray disk, or the like), a magnetic disk storage medium, other magnetic storage device, or any other medium that can be used to carry or store a computer program readable by a computer, but is not limited thereto.

The memory 4003 is used to store the computer program for executing the embodiments of the present disclosure, and the execution is controlled by the processor 4001. The processor 4001 is used to execute the computer program stored in the memory 4003 to implement the steps shown in the above method embodiments.

An embodiment of the present disclosure provides a computer-readable storage medium having a computer program stored thereon. When the computer program is executed by a processor, the steps and corresponding contents of the aforementioned method embodiment can be implemented. The embodiments of the present disclosure further provide a computer program product, including a computer program, which can implement the steps and corresponding contents of the aforementioned method embodiments when executed by a processor.

In the specification and claims and the accompanying drawings of the present disclosure, the terms “first”, “second”, “third”, “fourth”, “1”, “2”, and the like (if any) are used to distinguish similar objects and are not necessarily used to describe a particular order or sequence. It should be understood that the terms used in this manner are interchangeable where appropriate, such that the embodiments of the present disclosure described herein can be practiced in an order other than that illustrated or described.

It should be understood that, although the flowcharts of the embodiments of the present disclosure indicate the various operation steps by arrows, the order of implementation of these steps is not limited to the order indicated by the arrows. Unless otherwise clearly stated herein, in some implementation scenarios of the embodiments of the present disclosure, the implementation steps in each flowchart can be performed in other orders as required. In addition, some or all of the steps in each flowchart may include multiple sub-steps or multiple stages based on the actual implementation scenario. Some or all of these sub-steps or stages can be executed at the same time, and each sub-step or stage in these sub-steps or stages can also be executed at different times. In scenarios where the execution times are different, the order of execution of these sub-steps or stages can be flexibly configured as required, and the embodiments of the present disclosure do not limit this.

The above description is only an optional implementation method for some implementation scenarios of the present disclosure. It should be pointed out that for ordinary technicians in this technical field, without departing from the technical concept of the solution of the present disclosure, other similar implementation methods based on the technical ideas of the present disclosure also fall within the protection scope of the embodiments of the present disclosure.

1. A communication method, applied to a communication device and comprising:
delivering, by a first network function entity of the communication device, first configuration information downward to a second network function entity of the communication device, wherein the first configuration information is used to configure a first artificial intelligence (AI) model;
wherein the first network function entity and the second network function entity are network function entities of an access layer.

2. The method according to claim 1, further comprising:
determining, by the second network function entity, first transmission information based on the first configuration information, and delivering the first transmission information downward to a network function entity at lower layer;
wherein the first transmission information comprises the first configuration information and first indication information, wherein the first indication information is used to indicate that the first transmission information carries information of the first network function entity.

3. The method according to claim 1, wherein the second network function entity is a packet data convergence protocol (PDCP) entity or a radio resource control (RRC) entity.

4. The method according to claim 3, wherein the second network function entity is the PDCP entity, and the first transmission information is a first packet data convergence protocol protocol data unit (PDCP PDU),
wherein a radio bearer corresponding to the PDCP entity that obtains the first configuration information is the same as a radio bearer corresponding to the first network function entity or a radio bearer corresponding to the first AI model.

5. The method according to claim 3, wherein the second network function entity is the RRC entity, and the first transmission information is a first RRC message, wherein a radio bearer corresponding to the first RRC message is the same as a radio bearer corresponding to the first network function entity or a radio bearer corresponding to the first AI model.

6.-7. (canceled)

8. The method according to claim 1, wherein the delivering, by the first network function entity, the first configuration information downward to the second network function entity, further comprises:
obtaining, by the first network function entity, bearer information;
wherein the bearer information is used to indicate at least one of following:
a radio bearer corresponding to the first network function entity; or
a radio bearer corresponding to the first AI model.

9. The method according to claim 1, wherein the first configuration information comprises at least one of following:
adding information indicating an additional AI model, wherein the adding information comprises the additional AI model and a model identifier of the additional AI model;
modifying information indicating a modified AI model, wherein the modifying information comprises a model identifier of the modified AI model and a modified model parameter; or
deleting information indicating a deleted AI model, wherein the deleting information comprises a model identifier of the deleted AI model.

10. The method according to claim 1, further comprising:
obtaining, by the first network function entity, second configuration information delivered upward by the second network function entity, wherein the second configuration information is used to configure a second AI model; and
configuring, by the first network function entity, the second AI model based on the second configuration information.

11. The method according to claim 10, wherein before the obtaining, by the first network function entity, the second configuration information delivered upward by the second network function entity, the method further comprises:
obtaining, by the second network function entity, second transmission information delivered upward by a network function entity at lower layer, wherein the second transmission information comprises the second configuration information and second indication information, wherein the second indication information is used to indicate that the second transmission information carries information of the first network function entity; and
delivering the second transmission information upward to the first network function entity based on the second indication information.

12. The method according to claim 11, wherein the second network function entity is a PDCP entity, and the second transmission information is a second PDCP PDU,
wherein a radio bearer corresponding to the PDCP entity that obtains the second transmission information is the same as a radio bearer corresponding to the first network function entity or a radio bearer corresponding to the second AI model.

13. The method according to claim 11, wherein the second network function entity is an RRC entity, and the second transmission information is a second RRC message,
wherein a radio bearer corresponding to the second RRC message is the same as a radio bearer corresponding to the first network function entity or a radio bearer corresponding to the second AI model.

14.-15. (canceled)

16. The method according to claim 10, wherein the second configuration information comprises at least one of following:
adding information indicating an additional AI model, wherein the adding information comprises the additional AI model and a model identifier of the additional AI model;
modifying information indicating a modified AI model, wherein the modifying information comprises a model identifier of the modified AI model and a modified model parameter; or
deleting information indicating a deleted AI model, wherein the deleting information comprises a model identifier of the deleted AI model.

17. A communication method, applied to a first network function entity and comprising:
delivering first configuration information downward to a second network function entity;
wherein the first network function entity and the second network function entity are network function entities of an access layer; and
the first configuration information is used to configure a first artificial intelligence (AI) model.

18. (canceled)

19. The method according to claim 17, wherein the delivering the first configuration information to the second network function entity further comprises:
obtaining, by the first network function entity, bearer information;
wherein the bearer information is used to indicate at least one of following:
a radio bearer corresponding to the first network function entity; or
a radio bearer corresponding to the first AI model.

20. The method according to claim 17, wherein the first configuration information comprises at least one of following:
adding information indicating an additional AI model, wherein the adding information comprises the additional AI model and a model identifier of the additional AI model;
modifying information indicating a modified AI model, wherein the modifying information comprises a model identifier of the modified AI model and a modified model parameter; or
deleting information indicating a deleted AI model, wherein the deleting information comprises a model identifier of the deleted AI model.

21. The method according to claim 17, further comprising:
obtaining second configuration information delivered upward by the second network function entity, wherein the second configuration information is used to configure a second AI model; and
configuring the second AI model based on the second configuration information.

22. (canceled)

23. A communication method, applied to a second network function entity and comprising:
obtaining first configuration information delivered downward by a first network function entity;
wherein the first network function entity and the second network function entity are network function entities of an access layer; and
the first configuration information is used to configure a first artificial intelligence (AI) model.

24.-40. (canceled)

41. An electronic device comprising a memory, a processor, and a computer program stored in the memory, wherein the processor executes the computer program to implement steps of the method according to claim 1.

42. (canceled)

43. An electronic device comprising a memory, a processor, and a computer program stored in the memory, wherein the processor executes the computer program to implement steps of the method according to claim 17.

44. An electronic device comprising a memory, a processor, and a computer program stored in the memory, wherein the processor executes the computer program to implement steps of the method according to claim 23.
